(19) United States
(12) Patent Application Publication
(10) Pub. No.: US 2021/0129574 A1
(43) Pub. Date: May 6, 2021

(54) WRITING IMPLEMENT AND TOOL STORAGE UNIT WITH STRAP

(71) Applicant: DANIELLE MYERS, Murfreesboro, TN (US)

(72) Inventor: DANIELLE MYERS, Murfreesboro, TN (US)

(21) Appl. No.: 16/675,713

(22) Filed: Nov. 6, 2019

(51) Int. Cl. B42D 3/12; B43K 23/00

(52) U.S. Cl. CPC B42D 3/12; B42P 2241/18; B43K 23/00

(57) ABSTRACT

The present invention is a reusable writing implement and tool storage unit that attaches to a front and/or back book cover by a strap. Loops are created by stitching sections of an elastic ribbon to the front surface of the present invention. The loops are used to secure atleast one writing implement or tool therein.

### CROSS-REFERENCE TO RELATED APPLICATIONS

This non-provisional application claims priority to provisional patent application No. 62/756,454, entitled System for strapping writing tools to a hardbound book, filed on Nov. 6, 2018.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a reusable writing implement and tool storage unit which attaches to a front or back cover of a book so as to secure itself and allow the book to open without removing the case.

A writer or designer often needs a simple solution to store and access their writing implements and tools with their book or sketchbook. The present invention's strap and loops combines both of these functions making the device desirable.

Writing tool storage units for books have been disclosed in prior art, for example, U.S. Pat. No. 2011/0233915A1 of Palmer; U.S. Pat. No. 6,446,803 of McKinney; U.S. Pat. No. 2002/0083884A1 of Lucinda; U.S. Pat. No. 4,162,800 of Gonot. The known devices all use a pocket to store writing tools. Making the use of shorter pencils, crayons or pastels difficult to retrieve due to them falling deep within the pocket.

### BRIEF SUMMARY OF THE INVENTION

The disclosed invention is directed to a reusable multi-purpose device intended as a writing implement and tool storage unit attachment to use with a book.

It is an objective of the present invention to provide a storage solution for writing implements and tools. The present invention may be attached to either the front cover or back cover of a book.

A further objective of the present invention is to provide an easily accessible writing implement and tool storage solution that allows the user to open and close the book without having to remove or move the present invention.

A further objective of the present invention is to provide a storage solution to loose papers. The user can place loose papers between the elastic strap and book cover to secure said papers.

A further objective of the present invention is to provide a storage solution to short writing implements such as crayons and pastels. The user can access shorter writing implements through the loops since they are open on both ends.

### BRIEF DESCRIPTION OF THE SEVERAL VIEWS OF THE DRAWING

FIG. 1 is a perspective view of the preferred embodiment of the present invention inserted over a book cover.

FIG. 2 is a perspective view of the preferred embodiment of the present invention when not inserted over a book cover.

FIG. 3 is a perspective view of the preferred embodiment of the present invention when not inserted over a book cover.

FIG. 4 is a perspective view of the preferred embodiment of the present invention when inserted over a book cover.

FIG. 5 is a perspective view of an alternative embodiment of the present invention when inserted over a book cover with writing tools stored within the loops.

FIG. 6 is a perspective view of an alternative embodiment of the present invention when inserted over a book cover with having a zippered pocket and a card window.

FIG. 7 is a perspective view of an alternative embodiment of the present invention when inserted over a book cover with having a zippered pocket.

FIG. 8 is a perspective view of an alternative embodiment of the present invention when inserted over a book cover with having a zippered pocket that wraps around one or more sides of the present invention allowing storage for various writing implements and tools within the pocket.

FIG. 9 is a perspective view of an alternative embodiment of the present invention with an added handle when inserted over both book covers.

Referring to the drawings, 1 references the front surface of the present invention, 1a references the front surface of the present invention that wraps around the entire exterior of the book, 2 refers to the loops of the present invention, 3 refers to a book, 3a refers to a book cover, 3b refers to a book spine, 4 refers to the loop stitches of the present invention, 5 refers to the front and back surface stitches of the present invention, 6 refers to the strap of the present invention, 7 refers to the back surface of the present invention, 8 refers to loose papers, 9 refers to writing implements and tools, 10 refers to a zipper of an alternative embodiment, 11 refers to a window sleeve of an alternative embodiment, 12 refers to a window sleeve border of an alternative embodiment, 13 refers to a window sleeve card, 14 refers to a handle of an alternative embodiment, 15 refers to grommets of an alternative embodiment

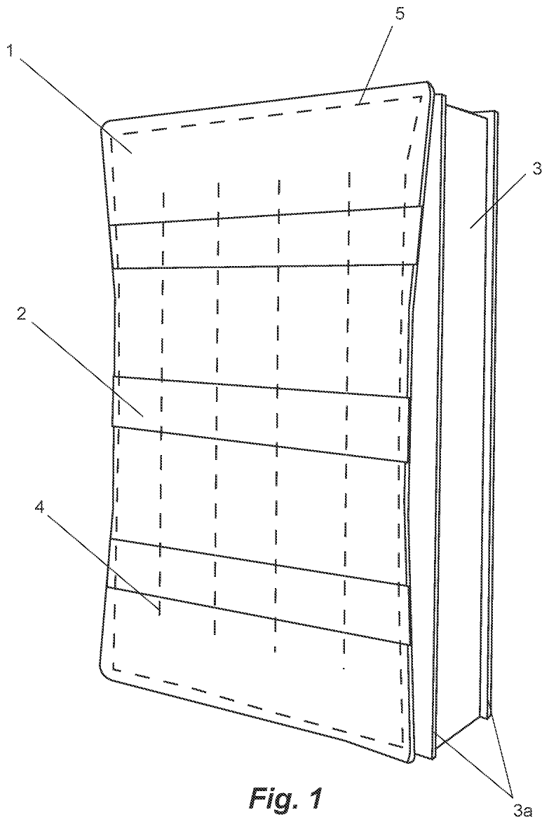

Referring to FIG. 1, the front surface 1, rests on top of a book's cover 3a, and the book 3 is closed, the elastic loops 2 rest on top of the front surface 1 and are divided by loop stitches 4, the preferred embodiment is held together by the front and back surface stitches 5.

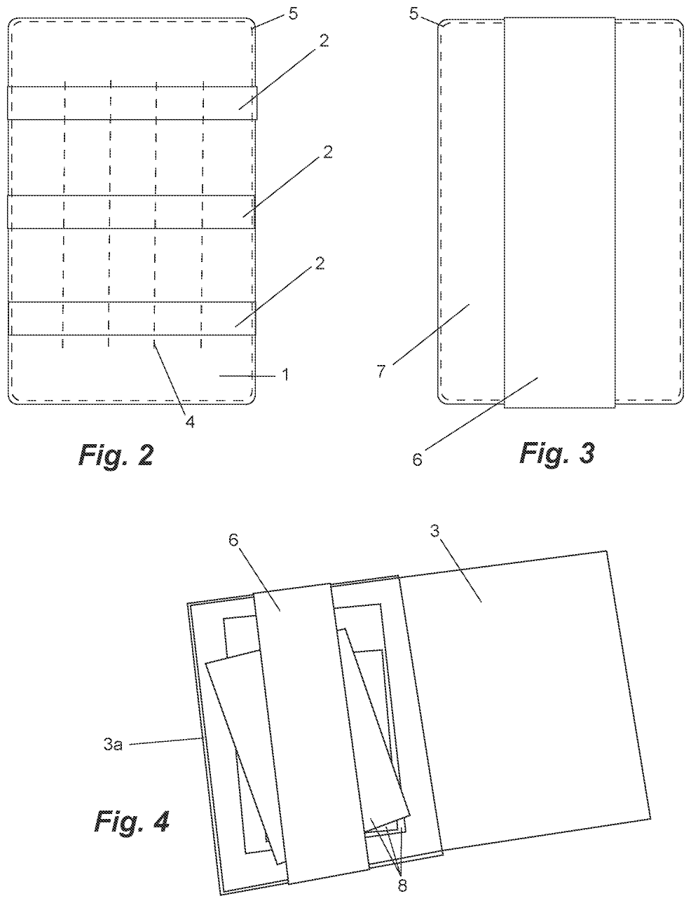

Referring to FIG. 2, the elastic loops 2, rest on top of the front surface 1, and are divided by loop stitches 4, the preferred embodiment is held together by the front and back surface stitches 5.

Referring to FIG. 3, the strap 6, rest on top of the back surface 7, and the strap 6 is held in place between the front surface 1, see FIG. 2, and back surface 7, by the front and back surface stitches 5.

Referring to FIG. 4, the strap 6, is wrapped around a book cover 3a, and the book 3 is open, and the strap 6 is securing the present invention to the book 3, and securing loose papers 8 between the strap 6, and the book cover 3a.

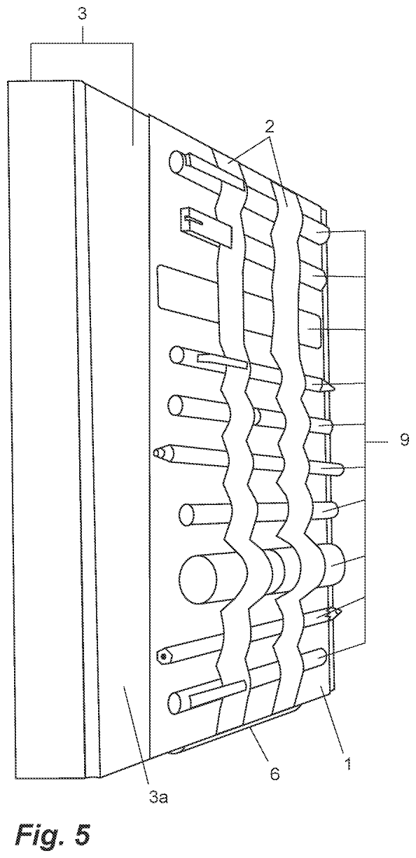

Referring to FIG. 5, the strap 6, is wrapped around the front of a book cover 3a, securing itsself to the book 3, which is closed. The loops 2, are securing various writing implements and tools 9, which are inserted between the loops 2, and the front surface 1. The book cover 3a, separates the strap 6, and the front surface 1, securing the present invention to the book 3.

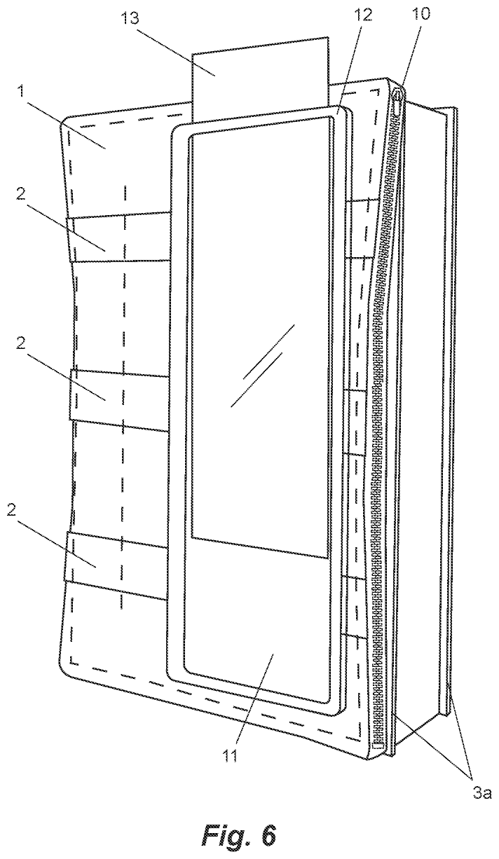

Referring to FIG. 6, an alternative embodiment, the front surface 1, has a window sleeve 11, secured by a window sleeve border 12, that allows a window sleeve card 13, to slide in and out of the window sleeve 11. A zipper 10, allows for secured storage between the front surface 1, and the back surface 7, depicted in FIG. 3.

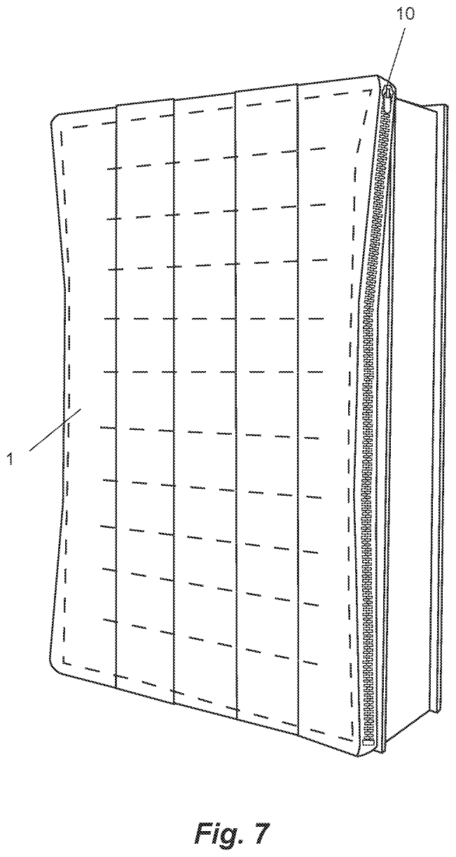

Referring to FIG. 7, an alternative embodiment, a zipper 10, allows for secured storage between the front surface 1, and the back surface 7, depicted in FIG. 3.

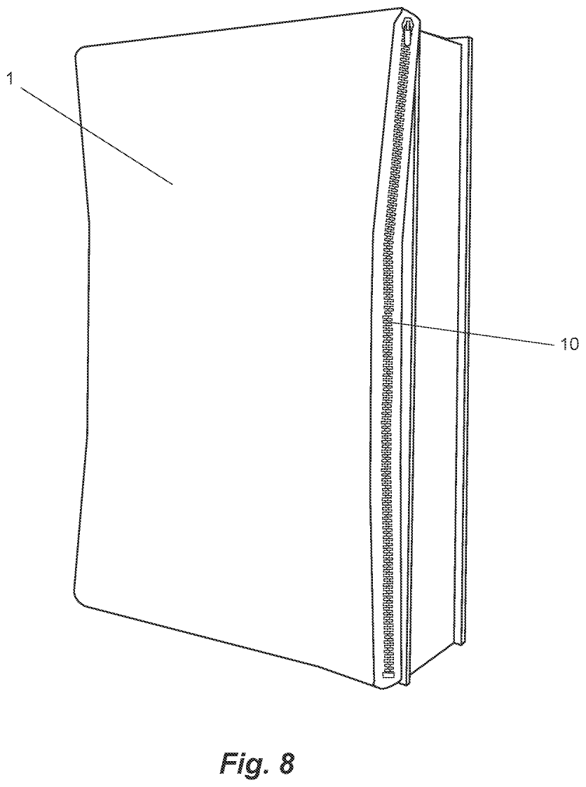

Referring to FIG. 8, an alternative embodiment, a zipper 10, allows for secured storage between the front surface 1, and the back surface 7, depicted in FIG. 3, and is void of loops 2, depicted in FIG. 1.

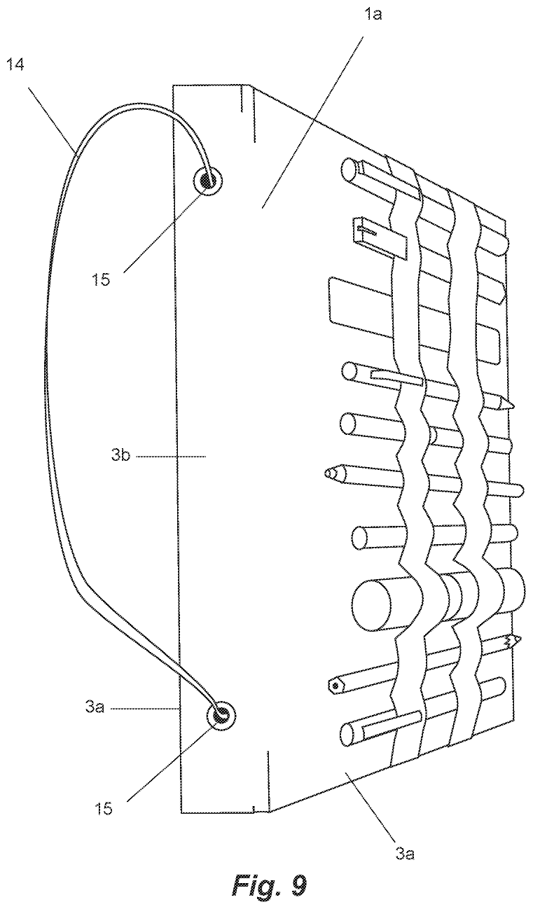

Referring to FIG. 9, an alternative embodiment, the front surface 1a, wraps around a book cover 3a, over book spine 3b, and around to the other book cover 3a, and has a handle 14, that is attached to the present invention by being inserted into grommets 15.

### DETAILED DESCRIPTION OF THE INVENTION

The construction of the preferred embodiment is as follows: One or more elastic ribbons are attached to a front surface by stitching perpendicularly to the ribbon and through the front surface. The stitches go through the ribbon creating loops in which the writing implement and/or tool will be placed within. An elastic strap of strength and width adapted for the purposes is placed on top of the front surface and a back surface is placed on top of the elastic strap. Both surfaces are placed in such a way that the right sides are facing each other and the wrong sides are facing the user. Stitches are then created around the surfaces' borders in such a way as to secure them to each other and hold the elastic strap in place. A small opening is left unstitched as to pull the elastic strap and right side surfaces through. Stitches then go around the front and back surface edges in such a way as to close the opening and give the piece a finished presentation.

I claim:

1. A writing implement and tool storage unit for attachment to a front and/or back book cover
comprising of an elastic strap stitched between front and back surfaces creating an enclosed encircled strap
with one or more elastic ribbons stitched to the front surface forming loops,
whereby securing one or more writing implements or tools in place.
